(19) United States
(12) Patent Application Publication
(10) Pub. No.: US 2017/0076208 A1
(43) Pub. Date: Mar. 16, 2017

(54) TERMINAL APPLICATION LAUNCHING METHOD, AND TERMINAL

(71) Applicant: Huawei Technologies Co., Ltd., Shenzhen (CN)

(72) Inventors: Maosheng Huang, Shenzhen (CN); Li Qian, Shenzhen (CN); Kangmin Huang, Shenzhen (CN); Shanfu Li, Shenzhen (CN)

(21) Appl. No.: 15/343,974

(22) Filed: Nov. 4, 2016

Related U.S. Application Data
(63) Continuation of application No. PCT/CN2014/090024, filed on Oct. 31, 2014.

(30) Foreign Application Priority Data
May 6, 2014 (CN) 201410189536.2

(51) Int. Cl. G06N 5/02

(52) U.S. Cl. CPC G06N 5/025; G06F 9/445

(57) ABSTRACT

A terminal application launching method and a terminal are disclosed. The method comprises: acquiring a contextual value of at least one contextor, where the contextor represents an information source that is available to a terminal and that is related to human-computer interaction, and the contextual value is a value that represents the contextor; determining, according to a decision rule, an application that matches the contextual value; determining a running parameter of the application according to the acquired contextual value and the determined application; and launching the application, where the application runs by using the running parameter. A corresponding terminal and another corresponding method and terminal are further disclosed. In embodiments of the present invention, according to a contextual value of a contextor of a terminal, automatic launching and running of the application of the terminal or automatic selection and launching of the application can be implemented.

### CROSS-REFERENCE TO RELATED APPLICATIONS

This application is a continuation of International Patent Application No. PCT/CN2014/090024, filed on Oct. 31, 2014, which claims priority to Chinese Patent Application No. 201410189536.2, filed on May 6, 2014, the disclosures of the aforementioned applications are hereby incorporated by reference in their entireties.

### TECHNICAL FIELD

The present invention relates to the field of application launching technologies of intelligent terminals, and in particular, to a terminal application launching method, and a terminal.

### BACKGROUND

Currently, abundant applications (Application, APP) such as Sina Weibo, WeChat, Credulity, a text editing application, Youdao Cloud Note, and media players such as Baidu Music, TPlayer, DuoMi Music, and StormPlayer are installed in various intelligent terminals such as a mobile phone, a tablet computer, and a wearable terminal. These applications greatly improve functions of the intelligent terminals, and facilitate the daily life and work of a user.

A user launches a corresponding application by performing a touch to select an application icon; or, a user performs a double-tap to select a parameter file, such as an MP3 music file, of an application. A system performs matching to find that multiple optional associated applications, such as TPlayer, DuoMi Music, and StormPlayer, may be all used as execution applications of the MP3 music file. The system provides a list of optional applications to be selected by the user; if the user makes no selection, the system performs no execution, and only after making a selection, the user executes a corresponding operation by using an application selected by the user. For example, if the user selects a TPlayer application, a terminal launches the TPlayer application, and opens the foregoing MP3 music file to play. An existing application launching technology cannot implement automatic launching of a suitable application; also, when the prior art is confronted with multiple optional associated applications, recommendation cannot be made intelligently to make a user make a selection; multiple similar applications confuse the user and the user does not know how to make a selection, which causes poor interaction experience and unfriendliness.

In the prior art, a contextual value of a contextor is obtained, and whether to perform an action on a computation apparatus is determined by using a decision engine and based on the contextual value; and if the decision engine determines to perform an action, the action is performed on the computation apparatus. In the invention, a feedback related to the action may be further used to update the decision engine. The action may be pre-launching the application before the user requests to execute the application. Pre-launching the application may decrease an application delay related to waiting for the user to request to execute the application before the application is launched. The patent provides a pre-launched application predicted based on a context, but only pre-launching is performed on the application, and finally, the user still needs to select to launch the application to launch the application, which causes insufficiently intelligent interaction, and insufficient friendliness and thoughtfulness to the user.

In conclusion, how to implement automatic launching of an application of a terminal or automatic selection and launching of an application becomes a problem that needs to be resolved at present.

### SUMMARY

Embodiments of the present invention provide a terminal application launching method, and a terminal, to implement automatic launching of an application of the terminal or automatic selection and launching of an application.

According to a first aspect, a terminal application launching method is provided, including:

acquiring a contextual value of at least one contextor, where the contextor represents an information source that is available to a terminal and that is related to human-computer interaction, and the contextual value is a value that represents the contextor;

determining, according to a decision rule, an application that matches the contextual value;

determining a running parameter of the application according to the acquired contextual value and the determined application; and

launching the application, where the application runs by using the running parameter.

In a first possible implementation manner, the determining, according to a decision rule, an application that matches the contextual value includes:

launching an application launching decision engine, so that the application launching decision engine determines, according to the decision rule, the application that matches the contextual value; and

acquiring the application that matches the contextual value and that is output by the application launching decision engine, where

the application launching decision engine includes the following decision rule: a Bayes classifier, a decision tree, a Support Vector Machine, a Hidden Markov Model, or a Gaussian Mixture Model.

With reference to the first aspect, in a second possible implementation manner, the determining a running parameter of the application according to the acquired contextual value and the determined application includes:

launching an application parameter decision engine, so that the application parameter decision engine determines the running parameter of the application according to the decision rule; and

acquiring the running parameter of the application that is output by the application parameter decision engine, where

the application parameter decision engine includes the following decision rule: a Bayes classifier, a decision tree, a Support Vector Machine, a Hidden Markov Model, or a Gaussian Mixture Model.

With reference to the first aspect or the first possible implementation manner of the first aspect or the second possible implementation manner of the first aspect, in a third possible implementation manner, the method further includes:

outputting a launching request prompt, to request a user to launch the application, where the application runs by using the running parameter, where

the launching the application includes:

launching the application when a launching instruction of the user is received.

According to a second aspect, a terminal application launching method is provided, including:

receiving an operation request of a user, where the operation request executes the operation request on one associated application of at least two associated applications;

acquiring a contextual value of at least one contextor of a terminal, where the contextor represents an information source that is available to a terminal and that is related to human-computer interaction, and the contextual value is a value that represents the contextor;

determining, from the at least two associated applications according to the contextual value, a first associated application that matches the contextual value; and

launching the first associated application, to execute the operation request.

In a first possible implementation manner, the method further includes:

determining a first running parameter of the first associated application according to the contextual value and the determined first associated application, where

the launching the first associated application, to execute the operation request includes:

launching the first associated application, to execute the operation request, where the first associated application runs by using the first running parameter.

With reference to the second aspect, in a second possible implementation manner, the method further includes:

outputting an associated application selection prompt, to prompt the user to select the first associated application or another associated application of the at least two associated applications; and

receiving a selection instruction of the user, where

the launching the first associated application, to execute the operation request includes:

if the selection instruction of the user is to select the first associated application, launching the first associated application, to execute the operation request, where the first associated application runs by using the first running parameter.

With reference to the second possible implementation manner of the second aspect, in a third possible implementation manner, if the selection instruction of the user is to select a second associated application of the at least two associated applications, the method further includes:

determining a second running parameter of the second associated application according to the contextual value and the selected second associated application; and

launching the second associated application, to execute the operation request, where the second associated application runs by using the second running parameter.

With reference to the second possible implementation manner of the second aspect or the third possible implementation manner of the second aspect, in a fourth possible implementation manner, after the receiving a selection instruction of the user, the method further includes:

acquiring a validity period selected by the user; and

when an operation request of the user is received, launching an associated application that is in the validity period and that corresponds to the operation request, to execute the operation request.

With reference to the fourth possible implementation manner of the second aspect, in a fifth possible implementation manner, the acquiring a validity period selected by the user includes:

outputting a selection interface of the validity period, to prompt the user to perform validity period selection; and

acquiring the validity period selected by the user.

With reference to the second aspect, in a sixth possible implementation manner, the contextor is a user mood, and the acquiring a contextual value of at least one contextor of a terminal includes:

launching a camera of the terminal, and acquiring an expression of the user; and

determining a contextual value of the user mood according to the expression of the user.

According to a third aspect, a terminal is provided, including:

a first acquiring unit, configured to acquire a contextual value of at least one contextor, where the contextor represents an information source that is available to a terminal and that is related to human-computer interaction, and the contextual value is a value that represents the contextor;

a first determining unit, configured to determine, according to a decision rule, an application that matches the contextual value;

a second determining unit, configured to determine a running parameter of the application according to the acquired contextual value and the determined application; and

a first launching unit, configured to launch the application, where the application runs by using the running parameter.

In a first possible implementation manner, the first determining unit includes:

a second launching unit, configured to launch an application launching decision engine, so that the application launching decision engine determines, according to the decision rule, the application that matches the contextual value; and

a second acquiring unit, configured to acquire the application that matches the contextual value and that is output by the application launching decision engine, where

the application launching decision engine includes the following decision rule: a Bayes classifier, a decision tree, a Support Vector Machine, a Hidden Markov Model, or a Gaussian Mixture Model.

With reference to the third aspect, in a second possible implementation manner, the second determining unit includes:

a third launching unit, configured to launch an application parameter decision engine, so that the application parameter decision engine determines the running parameter of the application according to the decision rule; and

a third acquiring unit, configured to acquire the running parameter of the application that is output by the application parameter decision engine, where

the application parameter decision engine includes the following decision rule: a Bayes classifier, a decision tree, a Support Vector Machine, a Hidden Markov Model, or a Gaussian Mixture Model.

With reference to the first aspect or the first possible implementation manner of the first aspect or the second possible implementation manner of the third aspect, in a third possible implementation manner, the terminal further includes:

an output unit, configured to output a launching request prompt, to request a user to launch the application, where the application runs by using the running parameter, where

the first launching unit is configured to launch the application when a launching instruction of the user is received.

According to a fourth aspect, a terminal is provided, including:

a first receiving unit, configured to receive an operation request of a user, where the operation request executes the operation request on one associated application of at least two associated applications;

a first acquiring unit, configured to acquire a contextual value of at least one contextor of the terminal, where the contextor represents an information source that is available to the terminal and that is related to human-computer interaction, and the contextual value is a value that represents the contextor;

a first determining unit, configured to determine, from the at least two associated applications according to the contextual value, a first associated application that matches the contextual value; and

a first launching unit, configured to launch the first associated application, to execute the operation request.

In a first possible implementation manner, the terminal further includes:

a second determining unit, configured to determine a first running parameter of the first associated application according to the contextual value and the determined first associated application, where

the first launching unit is configured to launch the first associated application, to execute the operation request, where the first associated application runs by using the first running parameter.

With reference to the fourth aspect, in a second possible implementation manner, the terminal further includes:

a first output unit, configured to output an associated application selection prompt, to prompt the user to select the first associated application or another associated application of the at least two associated applications; and

a second receiving unit, configured to receive a selection instruction of the user, where

the first launching unit is configured to: if the selection instruction of the user is to select the first associated application, launch the first associated application, to execute the operation request, where the first associated application runs by using the first running parameter.

With reference to the second possible implementation manner of the fourth aspect, in a third possible implementation manner, if the selection instruction of the user is to select a second associated application of the at least two associated applications, the terminal further includes:

a third determining unit, configured to determine a second running parameter of the second associated application according to the contextual value and the selected second associated application; and

a second launching unit, configured to launch the second associated application, to execute the operation request, where the second associated application runs by using the second running parameter.

With reference to the second possible implementation manner of the fourth aspect or the third possible implementation manner of the fourth aspect, in a fourth possible implementation manner, the terminal further includes:

a second acquiring unit, configured to acquire a validity period selected by the user; and

a third launching unit, configured to: when an operation request of the user is received, launch an associated application that is in the validity period and that corresponds to the operation request, to execute the operation request.

With reference to the fourth possible implementation manner of the fourth aspect, in a fifth possible implementation manner, the second acquiring unit includes:

a second output unit, configured to output a selection interface of the validity period, to prompt the user to perform validity period selection; and

a third acquiring unit, configured to acquire the validity period selected by the user.

With reference to the fourth aspect, in a sixth possible implementation manner, the contextor is a user mood, and the first acquiring unit includes:

a fourth acquiring unit, configured to launch a camera of the terminal, and acquire an expression of the user; and

a fourth determining unit, configured to determine a contextual value of the user mood according to the expression of the user.

It can be seen that, by means of the technical solutions of the terminal application launching method, and the terminal that are provided in the embodiments of the present invention, a matching application and a running parameter of the application are determined by using an obtained contextual value of a contextor of the terminal, where the application runs by using the running parameter, so that automatic launching and running of the application of the terminal can be implemented; and when selection is performed on an associated application corresponding to an operation request, an associated application that matches the contextual value is determined according to the obtained contextual value of the contextor of the terminal, so that automatic selection and launching of the application can be implemented, thereby improving user experience of the terminal.

### BRIEF DESCRIPTION OF THE DRAWINGS

FIG. 1 is a flowchart of a terminal application launching method according to an embodiment of the present invention;

FIG. 2 is a flowchart of another terminal application launching method according to an embodiment of the present invention;

FIG. 3 is a schematic diagram in which a graphical user interface is used to perform application launching prompt;

FIG. 4 is a flowchart of still another terminal application launching method according to an embodiment of the present invention;

FIG. 5 is a flowchart of still another terminal application launching method according to an embodiment of the present invention;

FIG. 6 is a schematic diagram of a graphical user interface recommended by an optimal application;

FIG. 7 is a schematic structural diagram of a terminal according to an embodiment of the present invention;

FIG. 8 is a schematic structural diagram of another terminal according to an embodiment of the present invention;

FIG. 9 is a schematic structural diagram of still another terminal according to an embodiment of the present invention;

FIG. 10 is a schematic structural diagram of still another terminal according to an embodiment of the present invention;

FIG. 11 is a schematic structural diagram of still another terminal according to an embodiment of the present invention; and

FIG. 12 is a schematic structural diagram of still another terminal according to an embodiment of the present invention.

### DETAILED DESCRIPTION

The following clearly describes the technical solutions in the embodiments of the present invention with reference to the accompanying drawings in the embodiments of the present invention. Apparently, the described embodiments are merely some but not all of the embodiments of the present invention. All other embodiments obtained by a person of ordinary skill in the art based on the embodiments of the present invention without creative efforts shall fall within the protection scope of the present invention.

Generally, a user may request to execute an application by identifying and selecting an icon, a tile, or another interface element representing the application by using, for example, a mouse, a scroll wheel, a touchscreen, or another input method. The icon may be selected from a desktop, a menu, or another interface. In the embodiments of the present invention, the term “launching” (launching) is a general term, and the general term includes various actions that generally occur in response to reception of such a user request of executing an application. For example, launching may include allocating a memory to an application and loading an application from a storage apparatus to the allocated memory. Launching may further include executing loaded application code, to execute a function that may be related to application initialization. For example, application code that retrieves data, such as a webpage, an image, or a video, from a network may be executed as a part of the launching. For example, processor resources such as threads or processes may also be allocated as a part of launching the application.

In the embodiments of the present invention, the term “contextor” (contextor) is generally used to represent an information source that is available to a terminal and that is from, for example, a sensor, an operating system, or a single application. In user experience, a foregoing context refers to a background in which a user uses a product, an environment, or a previous operation, and a following context refers to interaction that is about to occur in a product, an obtained feedback, or the like. It is generally considered that a contextor includes a physical scenario, a technical scenario, and a social scenario. The term “contextual value” is used to refer to a value of a single contextor, and makes a contextor be digitized or identifiable, and may include a direct value (for example, ambient temperature) or a value obtained in a logical manner (for example, by converting temperature into a term such as coldness or warmth). Unless otherwise noted particularly, the term “contextual value” used in this specification may refer to a current value or a historical value of a particular contextor. In some implementation manners, a contextor log is used to store history of a contextual value over time.

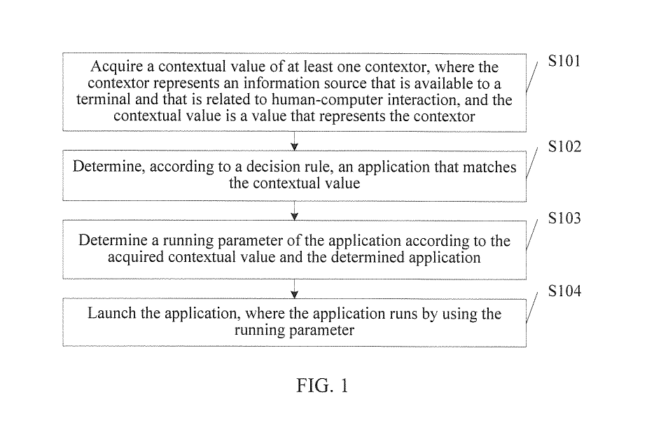

Refer to FIG. 1, which is a flowchart of a terminal application launching method according to an embodiment of the present invention. The method includes the following steps:

Step S101: Acquire a contextual value of at least one contextor of a terminal, where the contextor represents an information source that is available to the terminal and that is related to human-computer interaction, and the contextual value is a value that represents the contextor.

Herein, one or more contextors include time, a location, a phone log, ambient noise, ambient light, application use, and the like. For the time, a contextual value may be obtained from a terminal clock or a time server, or a contextual value may be obtained from a terminal clock and a time server; for the location, a contextual value may be obtained by means of a global positioning system (GPS) or cellular triangulation; for the phone log, a contextual value may be obtained from a call record application; for the ambient noise, a contextual value may be obtained from a terminal microphone; for the ambient light, a contextual value may be obtained from a terminal light sensor; and for the application use, a contextual value may be obtained from an operating system. Generally, each contextual value may be obtained locally at a terminal from, for example, a sensor, and in some cases, these contextual values are stored in one or more local contextor logs. However, in some cases, contextor logs may be maintained and stored remotely, for example, in a server, and the terminal retrieves these contextor logs.

For the contextor, other contextors may also be provided by using other information (such as an operating system log) maintained by various apparatus sensors of a terminal or the terminal.

In addition, a developer may establish a new contextor used to decide and select an application. For example, it is considered to install an electronic compass in a third-party application of a mobile apparatus. In this case, a corresponding contextor used to provide a value (for example, an azimuth or a logical direction (north, northwest or the like)) of the electronic compass may be installed. The use of the newly installed contextor may be learned. For example, regardless of whether the new contextor is provided by a manufacturer of a mobile apparatus, a developer (“first party”) of an operating system of a mobile apparatus, or a developer of a third-party application, the new contextor is “inserted” into an existing frame.

Step S102: Determine, according to a decision rule, an application that matches the contextual value.

The application launched by the apparatus previously and history of the contextual value may be used to learn to improve selection of an automatically launched application in a manner beneficial to a user. The application launched previously may be an automatically launched application decided previously according to the decision rule, or an application that the user triggers to launch (an application directly launched by the user by means of input without being launched by means of a decision). Corresponding to different contextors, applications that match the contextors may be determined according to different decision rules.

Step S103: Determine a running parameter of the application according to the acquired contextual value and the determined application.

Herein, parameters of an application may be a file and data that are input to the application, or various configuration settings of the application, for example, a parameter of a music player application may be, but is not limited to, a music file currently played by the player application (that is, a data file of a played song), a type of a music file (such as classical music, pop music, jazz music, or light music), an interface style of a player, a volume setting of played music, or the like.

For each application, according to a contextual value of a contextor, one or more running parameters of the application that matches the contextual value may be obtained. The running parameter of the application and the history of the contextual value may also be learned over time, to learn to improve parameter selection of the application in a manner beneficial to the user.

Step S104: Launch the application, where the application runs by using the running parameter.

The application is launched, where the application runs by using the determined running parameter of the application.

The entire launching process of the application needs no human participation, which completely implements automatic launching and running of the application of the terminal.

It can be seen that, according to the terminal application launching method provided in this embodiment of the present invention, a matching application and a running parameter of the application are determined by using an obtained contextual value of a contextor of a terminal, where the application runs by using the running parameter, so that automatic launching and running of the application of the terminal can be implemented, thereby improving user experience of the terminal.

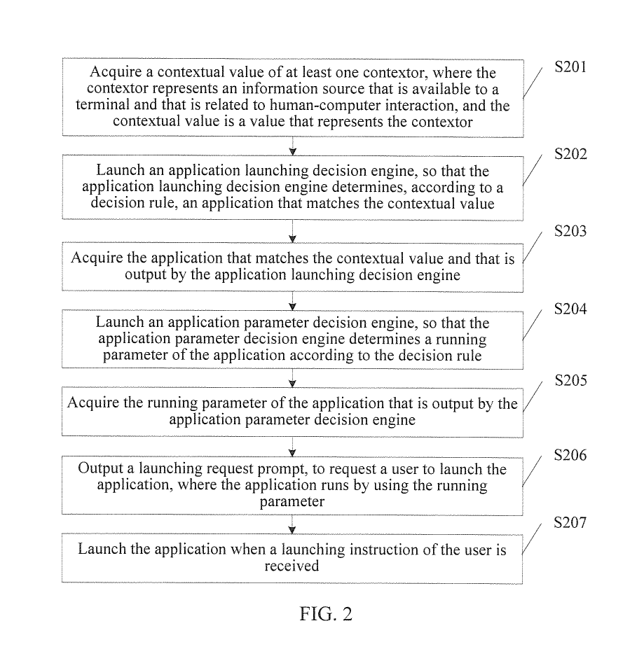

Refer to FIG. 2, which is a flowchart of another terminal application launching method according to an embodiment of the present invention.

Step S201: Acquire a contextual value of at least one contextor of a terminal, where the contextor represents an information source that is available to the terminal and that is related to human-computer interaction, and the contextual value is a value that represents the contextor.

Step S201 is the same as step S101 in the foregoing embodiment, and details are not described herein again.

Step S202: Launch an application launching decision engine, so that the application launching decision engine determines, according to a decision rule, an application that matches the contextual value.

Step S203: Acquire the application that matches the contextual value and that is output by the application launching decision engine.

Corresponding to different contextors, applications that match the contextors may be determined according to different decision rules, and specifically are executed by multiple application launching decision engines. The application launching decision engines may be implemented by using different decision algorithms, including a probability/statistical/random model, and online or offline learning or the like is performed by using a machine learning technology. Regardless of how a particular implementation manner of an application launching decision engine is, all the decision algorithms for implementation may be used to determine an application that needs to be launched. Generally, the application launched by the apparatus previously and history of the contextual value may be used to train a decision engine over time, so that the application launching decision engine learns to improve selection of an automatically launched application in a manner beneficial to a user. The application launched previously may be an automatically launched application decided by the application launching decision engine previously, or an application that the user triggers to launch (an application directly launched by the user by means of input without being launched by the application launching decision engine). As described in the foregoing description about the contextor, a first-party or third-party developer may also provide a new application launching decision engine, and may use an existing contextor to start making a decision to perform matching on an application that needs to be automatically launched.

A specific example of a proper decision algorithm of an application launching decision engine may include a Bayes (for example, naive Bayes) classifier, a decision tree (for example, very fast decision tree), a Support Vector Machine (Support Vector Machine, SVM), a Hidden Markov Model (Hidden Markov Model, HMM), a Gaussian Mixture Model (Gaussian Mixture Model, GMM), or the like.

As shown in the following Table 1, Table 1 is an example of a rule table of an application launching decision:

TABLE 1
Example of a rule table of an application launching decision

| | Decision launching | | |
|---|---|---|---|
| Rule | application | Time | Location |
| 301 | Music player application | 7:00 AM | Home |
| 302 | Baidu Map Navigation | 7:30 AM | Car |
| | application | | |
| 303 | Email application | 8:30 AM | Office |
| 304 | OFFICE office application | 9:30 PM | Office |
| 305 | Music player application | 9:30 PM | Home |

The contextor in the example includes time and a location. Rule 301: when time is 7:00 AM, and a location is “home”, a matching application is a “music player application”; rule 302: when current time is 7:30 AM, and a location is “car”, a matching application is a “Baidu Map Navigation application”; rule 303: when current time is 8:30 AM, and a location is “office”, a matching application is an “email application”; rule 304: when current time is 9:30 PM, and a location is “office”, a matching application is an “OFFICE office application”; and rule 305: when current time is 9:30 PM, and a location is “home”, a matching application is a “music player application”.

Step S204: Launch an application parameter decision engine, so that the application parameter decision engine determines a running parameter of the application according to the decision rule.

Step S205: Acquire the running parameter of the application that is output by the application parameter decision engine.

The application parameter decision engine is launched, and the application parameter decision engine performs matching according to the contextual value of the contextor and the application that is output by the application launching decision engine, to obtain a running parameter of the application. The application parameter decision engine may be implemented by using different decision algorithms, including a probability/statistical/random model, and online or offline learning or the like is performed by using a machine learning technology. Regardless of how a particular implementation manner of an application parameter decision engine is, all the decision algorithms for implementation may be used to determine, according to an input application and a provided contextual value, a running parameter adaptive to the application. Generally, the previous running parameter of the application and the history of the contextual value may be used to train an application parameter decision engine over time, so that the application parameter decision engine learns to improve parameter selection of the application in a manner beneficial to the user. As described in the foregoing description about the contextor, a first-party or third-party developer may also provide new application parameter decision engines, where the new application parameter decision engines are directly inserted, and may use an existing contextor to start making a decision to perform matching on a parameter of the application. For example, the apparatus may be from a manufacturer and include a naive Bayes decision engine, and a third-party developer may subsequently provide a time-windowed (time-windowed) very fast decision tree (very fast decision tree) decision engine inserted into an application mapping module.

A decision algorithm of an application parameter decision engine may specifically include, but is not limited to, a Bayes (for example, naive Bayes) classifier, a decision tree (for example, very fast decision tree), a Support Vector Machine (SVM), a Hidden Markov Model (HMM), a Gaussian Mixture Model (GMM), or the like.

As shown in the following Table 2, Table 2 is an example of a rule table of an application parameter decision:

TABLE 2
Example of a rule table of an application parameter decision

| | | | | Application |
|---|---|---|---|---|
| | | | | decided by an |
| | | | | application |
| | Decision application | | | launching |
| Rule | parameter | Time | Location | decision engine |
| 401 | Exercise Song, and | 7:00 AM | Home | Music player |
| | volume: 100% | | | application |
| 402 | Merry Christmas, and | 7:00 AM on | Home | Music player |
| | volume: 100% | December 25 | | application |
| 403 | Happy Birthday, and | 7:00 AM on | Home | Music player |
| | volume: 100% | Birthday | | application |
| 404 | Lullaby, light music, | 9:30 PM | Home | Music player |
| | volume: 30% | | | application |

The contextor in the example includes time and a location, and an application decided by an application launching decision engine is a “music player application”. Rule 401: when time is 7:00 AM, and a location is “home”, a parameter that matches a “music player application” is “Exercise Song, and volume: 100%”; rule 402: when time is 7:00 AM on December 25, and a location is “home”, a parameter that matches a “music player application” is “Merry Christmas, and volume: 100%”; rule 403: when time is 7:00 AM on birthday of a user, and a location is “home”, a parameter that matches a “music player application” is “Happy Birthday, and volume: 100%”; and rule 404: when time is 9:30 PM, and a location is “home”, a parameter that matches a “music player application” is “Lullaby, and volume: 30%”.

Step S206: Output a launching request prompt, to request a user to launch the application, where the application runs by using the running parameter.

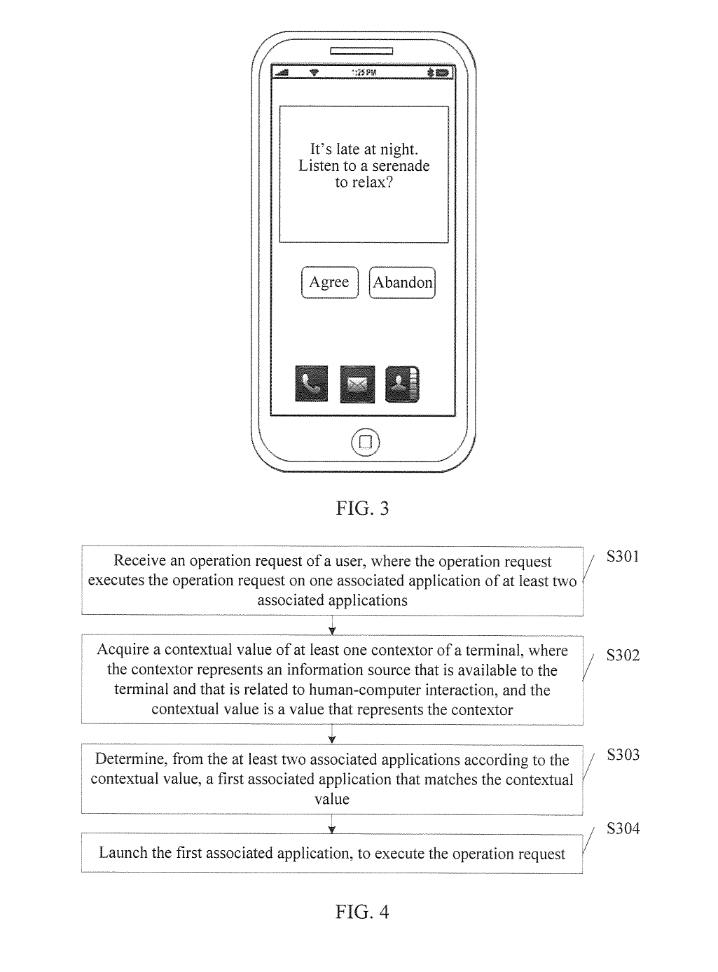

An output manner may be giving a prompt on a graphical user interface (Graphical User Interface, GUI) by using a display, and displaying an input confirmation option, to receive a launching instruction of the user; or may be voice output, prompting the user in a voice manner, and waiting for confirmation of voice input of the user. FIG. 3 is a schematic diagram in which a prompt of a graphical user interface GUI is given.

In an implementation manner, after step S205 and before step S206, the method may further include a step: Pre-launch the application. Herein, the pre-launching refers to executing at least a part of launching of an application, to place the application in a pre-launched state (code/data has been loaded to a memory, code has been executed, or the like).

Step S207: Launch the application when a launching instruction of the user is received.

For example, as shown in FIG. 3, the user may select “Agree” or “Abandon”; if the user selects “Agree”, that is, the launching instruction of the user is received, for each application, the application is launched by using the acquired one or more parameters; and if the user selects “Abandon”, the application is not launched.

It can be seen that, according to the terminal application launching method provided in this embodiment of the present invention, a matching application and a running parameter of the application are determined by using an obtained contextual value of a contextor of a terminal, and the application is launched, where the application runs by using the running parameter, so that automatic launching of the application of the terminal can be implemented, thereby improving user experience of the terminal; also, after an application that needs to be automatically launched in a next step and a running parameter of the application are obtained, the application and the running parameter are provided, in a prompting manner, for a user to select, so that the terminal is not excessively mighty while being intelligent and thoughtful, and the user may independently decide whether to launch an application, but the prompt only needs to be simply confirmed by the user, without seeking for an application and a parameter related to the application, which provides the user with good interaction experience.

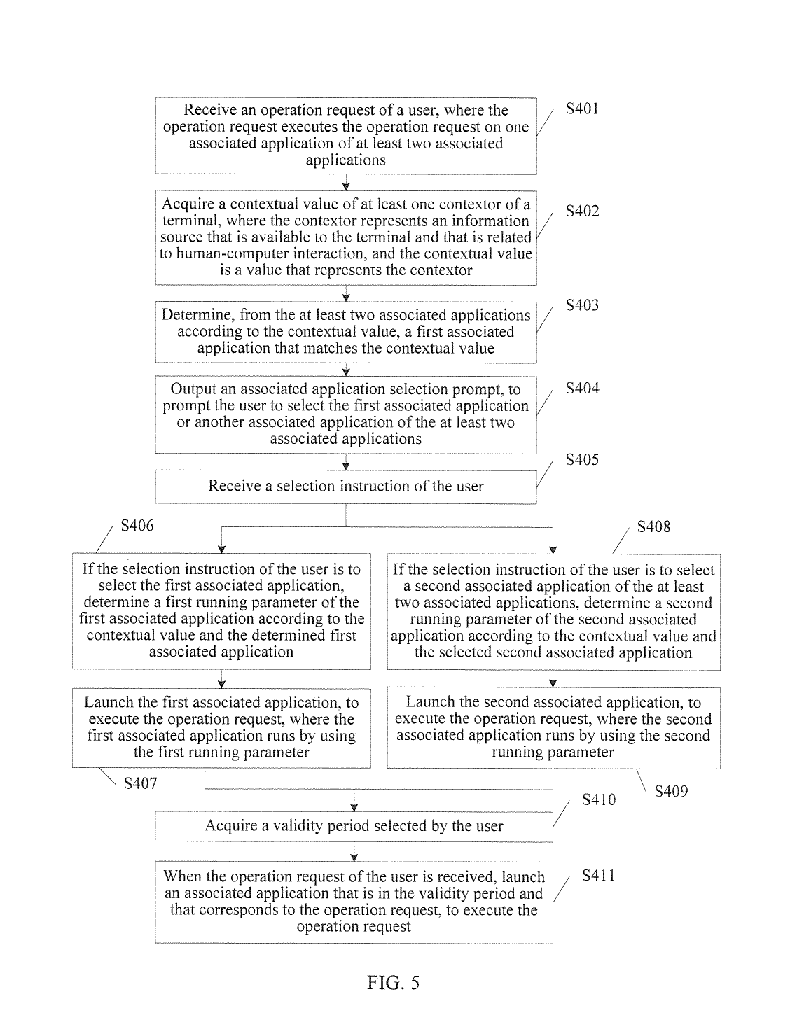

Refer to FIG. 4, which is a flowchart of still another terminal application launching method according to an embodiment of the present invention. The method includes the following steps:

Step S301: Receive an operation request of a user, where the operation request executes the operation request on one associated application of at least two associated applications.

An operation request of a user is received, where the operation request executes the operation request on one associated application of the at least two associated applications. The operation request may be, but is not limited to, input performed by using a touchscreen, a keyboard, a mouse or the like, or may be voice input, or may be gesture input, or the like. For example, if a command is “open a music file” or “open a photograph”, this operation request of opening a music file needs to launch an application such as “music player”, and a terminal may include multiple associated applications “music players”, such as Baidu Music, TPlayer, DuoMi Music, and StormPlayer.

Step S302: Acquire a contextual value of at least one contextor of a terminal, where the contextor represents an information source that is available to the terminal and that is related to human-computer interaction, and the contextual value is a value that represents the contextor.

Herein, one or more contextors include time, a location, a phone log, ambient noise, ambient light, application use, and the like. For the time, a contextual value may be obtained from a terminal clock or a time server; for the location, a contextual value may be obtained by means of a GPS or cellular triangulation; for the phone log, a contextual value may be obtained from a call record application; for the ambient noise, a contextual value may be obtained from a terminal microphone; for the ambient light, a contextual value may be obtained from a terminal light sensor; and for the application use, a contextual value may be obtained from an operating system. Generally, each contextual value may be obtained locally at a terminal from, for example, a sensor, and in some cases, these contextual values are stored in one or more local contextor logs. However, in some cases, contextor logs may be maintained and stored remotely, for example, in a server, and the terminal retrieves these contextor logs.

For the contextor, other contextors may also be provided by using other info nation (such as an operating system log) maintained by various apparatus sensors of a terminal or the terminal.

The contextor may further be a user mood, and the step of acquiring a contextual value of the user mood may be:

launching a camera of the terminal, and acquiring an expression of the user; and

determining a contextual value of the user mood according to the expression of the user.

In addition, a developer may establish a new contextor used to decide and select an application. For example, it is considered to install an electronic compass in a third-party application of a mobile apparatus. In this case, a corresponding contextor used to provide a value (for example, an azimuth or a logical direction (north, northwest or the like)) of the electronic compass may be installed. The use of the newly installed contextor may be learned. For example, regardless of whether the new contextor is provided by a manufacturer of a mobile apparatus, a developer (“first party”) of an operating system of a mobile apparatus, or a developer of a third-party application, the new contextor is “inserted” into an existing frame.

Step S303: Determine, from the at least two associated applications according to the contextual value, a first associated application that matches the contextual value.

One or more application launching decision engines may be used to make a decision on input of a contextual value of a contextor, to obtain an optimal application of multiple optional associated applications. Specifically, different application launching decision engines may make decisions according to one or more application launching decision rules or algorithms. A decision algorithm of an application launching decision engine may specifically include, but is not limited to, a Bayes (for example, naive Bayes) classifier, a decision tree (for example, very fast decision tree), a Support Vector Machine, a Hidden Markov Model, a Gaussian Mixture Model, or the like.

For example, assuming that in a historical operation, a user uses a “Baidu Music application” in the morning, uses a “TPlayer application” in the afternoon, and uses a “DuoMi Music application” in the evening, when current time of a contextor is 8:00 AM, an optimal application obtained through matching is the “Baidu Music application”; and when current time of the contextor is 2:00 PM, an optimal application obtained through matching is the “TPlayer application”. For another example, a contextual value of the contextor may perceive a mood mode of a user, and assuming that when a decision rule is “excited mood”, the user selects a “Baidu Music application”; and when a decision rule is “depressed mood”, the user selects a “TPlayer application”, when the current contextual value obtains an “excited mood” mode, an optimal application obtained through matching is the “Baidu Music application”. In an embodiment, contextors may further include evaluation and a use amount of social network friends for the multiple optional associated applications, and contextual values of these contextors may be acquired via a network, or may be obtained by a related context management module deployed in a server.

Step S304: Launch the first associated application, to execute the operation request.

The optimal application is launched, to execute the operation request of the user. For example, if a music player obtained through matching is Baidu Music, music that the user requests to play is played by using Baidu Music.

It can be seen that, according to the terminal application launching method provided in this embodiment of the present invention, when selection is performed on an associated application corresponding to an operation request, according to an obtained contextual value of a contextor of a terminal, an associated application that matches the contextual value is determined, so that automatic selection and launching of the application can be implemented, thereby improving user experience of the terminal.

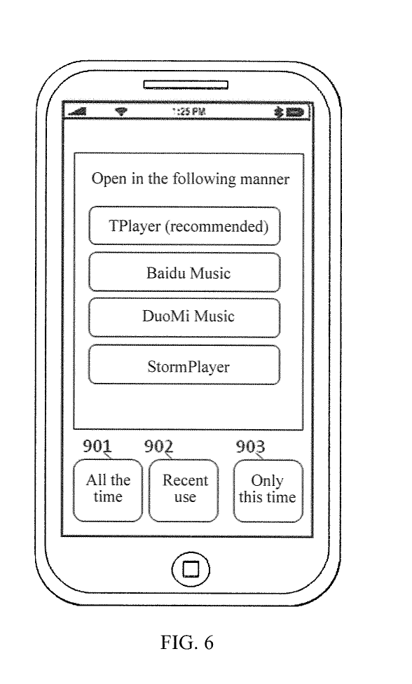

Refer to FIG. 5, which is a flowchart of still another terminal application launching method according to an embodiment of the present invention. The method includes the following steps:

Step S401: Receive an operation request of a user, where the operation request executes the operation request on one associated application of at least two associated applications.

Step S402: Acquire a contextual value of at least one contextor of a terminal, where the contextor represents an information source that is available to the terminal and that is related to human-computer interaction, and the contextual value is a value that represents the contextor.

Step S403: Determine, from the at least two associated applications according to the contextual value, a first associated application that matches the contextual value.

Step S401 to step S403 are the same as step S301 to step S303 of the embodiment shown in FIG. 4 respectively, and details are not described herein again.

Step S404: Output an associated application selection prompt, to prompt the user to select the first associated application or another associated application of the at least two associated applications.

Step S405: Receive a selection instruction of the user.

An optimal application obtained through matching and other applications associated with the operation request are output to the user, for the user to select. An output manner may be giving a prompt on a graphical user interface by using a display, and displaying an input confirmation option, to receive a launching instruction of the user; or may be voice output, prompting the user in a voice manner, and waiting for confirmation of voice input of the user. FIG. 6 is a schematic diagram of a graphical user interface recommended by an optimal application. In FIG. 6, a user is prompted that an optimal application recommended by a system is “TPlayer”. However, the user may also use “Baidu Music”, “DuoMi Music”, or “StormPlayer” to open a music file. Moreover, the selection instruction of the user is received.

Step S406: If the selection instruction of the user is to select the first associated application, determine a first running parameter of the first associated application according to the contextual value and the determined first associated application.

Step S407: Launch the first associated application, to execute the operation request, where the first associated application runs by using the first running parameter.

If the received selection instruction of the user is to select a first application, that is, an optimal application, matching is performed according to the contextual value of the contextor to obtain one or more running parameters of the optimal application. Herein, running parameters of an application may be a file and data that are input to the application, or various configuration settings of the application, for example, a parameter of a music player application may be, but is not limited to, a music file currently played by the player application (that is, a data file of a played song), a type of a music file (such as classical music, pop music, jazz music, or light music), an interface style of a player, a volume setting of played music, or the like. The parameter of the application and history of the contextual value may also be learned over time, to learn to improve parameter selection of the application in a manner beneficial to the user.

Step S408: If the selection instruction of the user is to select a second associated application of the at least two associated applications, determine a second running parameter of the second associated application according to the contextual value and the selected second associated application.

Step S409: Launch the second associated application, to execute the operation request, where the second associated application runs by using the second running parameter.

If the received selection instruction of the user is to select a second associated application of other applications, a second running parameter of the second associated application needs to be acquired again according to the contextual value of the contextor, and the second associated application is launched, where the second associated application runs by using the second running parameter. Parameter matching and application launching processes of the second associated application are the same as parameter matching and application launching processes of the optimal application, and details are not described herein again.

Step S410: Acquire a validity period selected by the user.

Step S411: When the operation request of the user is received, launch an associated application that is in the validity period and that corresponds to the operation request, to execute the operation request.

As shown in FIG. 6, options selected and confirmed by a user include options 901 “All the time”, 902 “Recent use”, and 903 “Only this time”. Herein, the option 903 “Only this time” indicates that an associated application selected by the user is used only once, and when the associated application is needed in a subsequent similar command, selection needs to be decided again; the option 901 “All the time” indicates that an operation request of the user may be replaceably bound to an associated application selected by the user, and when the associated application is needed in a subsequent similar command, a current user selection is used, that is, the application is set to a default application. The option 902 “Recent use” is an option between the foregoing two options, which is neither applicable for once to an associated application currently selected by the user, nor applicable all the time to the application that is set to a default application, but is applicable to a same user command in a particular quantity of times or a particular period. Herein, the particular quantity of times or the particular period may be configured by a terminal, and may be adjusted by a user. For example, a user command requests to open an MP3 music file, optional associated applications include “Baidu Music”, “TPlayer”, “DuoMi Music”, “StormPlayer” and the like, and the user selects the “Baidu Music” and selects the “Recent use”. In configuration of an apparatus, “Recent use” is, for example, configured as 10 times (or 7 days), and for a subsequent similar command of opening a music file, the user selects a “Baidu Music” application in 10 times (or 7 days) by default to open the music file, and beyond the quantity of times or period, the user needs to re-decide to select an associated application for the command of opening a music file.

It can be seen that, according to the terminal application launching method provided in this embodiment of the present invention, when selection is performed on an associated application corresponding to an operation request, according to an obtained contextual value of a contextor of a terminal, an associated application that matches the contextual value is determined, so that automatic selection and launching of the application can be implemented, thereby improving user experience of the terminal; also, after an optimal application associated with the operation request is obtained through matching and a parameter of the optimal application is launched, a user is prompted to independently decide to select a recommended optimal application or other applications associated with the operation request, for the user to select, so that the terminal is not excessively mighty while being intelligent and thoughtful, but the prompt only needs to be simply confirmed by the user, without seeking for an application and a parameter related to the application, which provides the user with good interaction experience.

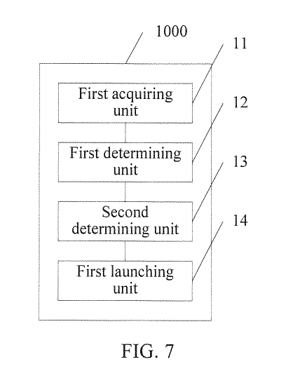

Refer to FIG. 7, which is a schematic structural diagram of a terminal according to an embodiment of the present invention. The terminal 1000 includes a first acquiring unit 11, a first determining unit 12, a second determining unit 13, and a first launching unit 14.

The first acquiring unit 11 is configured to acquire a contextual value of at least one contextor, where the contextor represents an information source that is available to the terminal and that is related to human-computer interaction, and the contextual value is a value that represents the contextor.

Herein, one or more contextors include time, a location, a phone log, ambient noise, ambient light, application use, and the like. For the time, the first acquiring unit 11 may obtain a contextual value from a terminal clock or a time server; for the location, the first acquiring unit 11 may obtain a contextual value by means of a global positioning system (Global Positioning System, GPS) or cellular triangulation; for the phone log, the first acquiring unit 11 may obtain a contextual value from a call record application; for the ambient noise, the first acquiring unit 11 may obtain a contextual value from a terminal microphone; for the ambient light, the first acquiring unit 11 may obtain a contextual value from a terminal light sensor; and for the application use, the first acquiring unit 11 may obtain a contextual value from an operating system. Generally, the first acquiring unit 11 may obtain each contextual value locally at the terminal from, for example, a sensor, and in some cases, these contextual values are stored in one or more local contextor logs. However, in some cases, the first acquiring unit 11 may maintain and store contextor logs remotely, for example, in a server, and the terminal retrieves these contextor logs.

For the contextor, other contextors may also be provided by using other information (such as an operating system log) maintained by various apparatus sensors of a terminal or the terminal.

In addition, a developer may establish a new contextor used to decide and select an application. For example, it is considered to install an electronic compass in a third-party application of a mobile apparatus. In this case, a corresponding contextor used to provide a value (for example, an azimuth or a logical direction (north, northwest or the like)) of the electronic compass may be installed. The use of the newly installed contextor may be learned. For example, regardless of whether the new contextor is provided by a manufacturer of a mobile apparatus, a developer (“first party”) of an operating system of a mobile apparatus, or a developer of a third-party application, the new contextor is “inserted” into an existing frame.

The first determining unit 12 is configured to determine, according to a decision rule, an application that matches the contextual value.

The application launched by the apparatus previously and history of the contextual value may be used to learn to improve selection of an automatically launched application in a manner beneficial to a user. The application launched previously may be an automatically launched application decided previously according to the decision rule, or an application that the user triggers to launch (an application directly launched by the user by means of input without being launched by means of a decision). Corresponding to different contextors, the first determining unit 12 may determine, according to different decision rules, applications that match the contextors.

A second determining unit 13 is configured to determine a running parameter of the application according to the acquired contextual value and the determined application.

Herein, parameters of an application may be a file and data that are input to the application, or various configuration settings of the application, for example, a parameter of a music player application may be, but is not limited to, a music file currently played by the player application (that is, a data file of a played song), a type of a music file (such as classical music, pop music, jazz music, or light music), an interface style of a player, a volume setting of played music, or the like.

For each application, according to a contextual value of a contextor, the second determining unit 13 may obtain one or more running parameters of the application that matches the contextual value. The running parameter of the application and the history of the contextual value may also be learned over time, to learn to improve parameter selection of the application in a manner beneficial to the user.

The first launching unit 14 is configured to launch the application, where the application runs by using the running parameter.

The first launching unit 14 launches the application, where the application runs by using the determined running parameter of the application.

The entire launching process of the application needs no human participation, which completely implements automatic launching and running of the application of the terminal.

It can be seen that, according to the terminal provided in this embodiment of the present invention, a matching application and a running parameter of the application are determined by using an obtained contextual value of a contextor of the terminal, where the application runs by using the running parameter, so that automatic launching and running of the application of the terminal can be implemented, thereby improving user experience of the terminal.

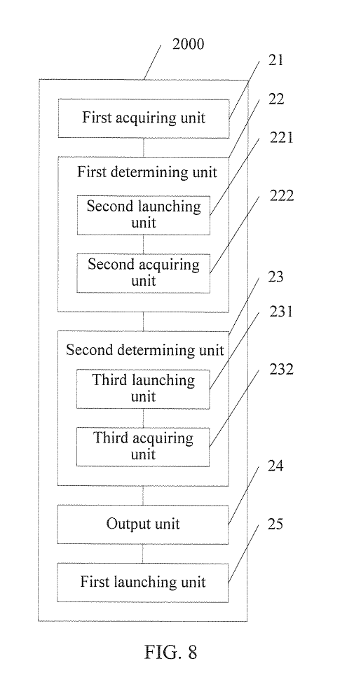

Refer to FIG. 8, which is a schematic structural diagram of another terminal according to an embodiment of the present invention. The terminal 2000 includes a first acquiring unit 21, a first determining unit 22, a second determining unit 23, an output unit 24, and a first launching unit 25.

The first acquiring unit 21 is configured to acquire a contextual value of at least one contextor of the terminal, where the contextor represents an information source that is available to the terminal and that is related to human-computer interaction, and the contextual value is a value that represents the contextor.

The function of the first acquiring unit 21 is the same as that of the first acquiring unit 11 in the foregoing embodiment, and details are not described herein again.

The first determining unit 22 is configured to determine, according to a decision rule, an application that matches the contextual value.

In this embodiment, the first determining unit 22 includes a second launching unit 221 and a second acquiring unit 222.

The second launching unit 221 is configured to launch an application launching decision engine, so that the application launching decision engine determines, according to the decision rule, the application that matches the contextual value.

The second acquiring unit 222 is configured to acquire the application that matches the contextual value and that is output by the application launching decision engine.

Corresponding to different contextors, applications that match the contextors may be determined according to different decision rules, and specifically are executed by multiple application launching decision engines. The application launching decision engines may be implemented by using different decision algorithms, including a probability/statistical/random model, and online or offline learning or the like is performed by using a machine learning technology. Regardless of how a particular implementation manner of an application launching decision engine is, all the decision algorithms for implementation may be used to determine an application that needs to be launched. Generally, the application launched by the apparatus previously and history of the contextual value may be used to train a decision engine over time, so that the application launching decision engine learns to improve selection of an automatically launched application in a manner beneficial to a user. The application launched previously may be an automatically launched application decided by the application launching decision engine previously, or an application that the user triggers to launch (an application directly launched by the user by means of input without being launched by the application launching decision engine). As described in the foregoing description about the contextor, a first-party or third-party developer may also provide a new application launching decision engine, and may use an existing contextor to start making a decision to perform matching on an application that needs to be automatically launched.

A specific example of a proper decision algorithm of an application launching decision engine may include a Bayes (for example, naive Bayes) classifier, a decision tree (for example, very fast decision tree), a Support Vector Machine (Support Vector Machine, SVM), a Hidden Markov Model (Hidden Markov Model, HMM), a Gaussian Mixture Model (Gaussian Mixture Model, GMM), or the like.

As shown in an example of a rule table of an application launching decision shown in Table 1, the contextor in the example includes time and a location. Rule 301: when time is 7:00 AM, and a location is “home”, a matching application is a “music player application”; rule 302: when current time is 7:30 AM, and a location is “car”, a matching application is a “Baidu Map Navigation application”; rule 303: when current time is 8:30 AM, and a location is “office”, a matching application is an “email application”; rule 304: when current time is 9:30 PM, and a location is “office”, a matching application is an “OFFICE office application”; and rule 305: when current time is 9:30 PM, and a location is “home”, a matching application is a “music player application”.

The second determining unit 23 is configured to determine a running parameter of the application according to the acquired contextual value and the determined application.

In this embodiment, the second determining unit 23 includes a third launching unit 231 and a third acquiring unit 232.

The third launching unit 231 is configured to launch an application parameter decision engine, so that the application parameter decision engine determines the running parameter of the application according to the decision rule.

The third acquiring unit 232 is configured to acquire the running parameter of the application that is output by the application parameter decision engine.

The application parameter decision engine is launched, and the application parameter decision engine performs matching according to the contextual value of the contextor and the application that is output by the application launching decision engine, to obtain a running parameter of the application. The application parameter decision engine may be implemented by using different decision algorithms, including a probability/statistical/random model, and online or offline learning or the like is performed by using a machine learning technology. Regardless of how a particular implementation manner of an application parameter decision engine is, all the decision algorithms for implementation may be used to determine, according to an input application and a provided contextual value, a running parameter adaptive to the application. Generally, the previous running parameter of the application and the history of the contextual value may be used to train an application parameter decision engine over time, so that the application parameter decision engine learns to improve parameter selection of the application in a manner beneficial to the user. As described in the foregoing description about the contextor, a first-party or third-party developer may also provide new application parameter decision engines, where the new application parameter decision engines are directly inserted, and may use an existing contextor to start making a decision to perform matching on a parameter of the application. For example, the apparatus may be from a manufacturer and include a naive Bayes decision engine, and a third-party developer may subsequently provide a time-windowed (time-windowed) very fast decision tree (very fast decision tree) decision engine inserted into an application mapping module.

A decision algorithm of an application parameter decision engine may specifically include, but is not limited to, a Bayes (for example, naive Bayes) classifier, a decision tree (for example, very fast decision tree), a Support Vector Machine (SVM), a Hidden Markov Model (HMM), a Gaussian Mixture Model (GMM), or the like.

As shown in an example of a rule table of an application parameter decision shown in Table 2, the contextor in the example includes time and a location, and an application decided by an application launching decision engine is a “music player application”. Rule 401: when time is 7:00 AM, and a location is “home”, a parameter that matches a “music player application” is “Exercise Song, and volume: 100%”; rule 402: when time is 7:00 AM on December 25, and a location is “home”, a parameter that matches a “music player application” is “Merry Christmas, and volume: 100%”; rule 403: when time is 7:00 AM on birthday of a user, and a location is “home”, a parameter that matches a “music player application” is “Happy Birthday, and volume: 100%”; and rule 404: when time is 9:30 PM, and a location is “home”, a parameter that matches a “music player application” is “Lullaby, and volume: 30%”.

An output unit 24 is configured to output a launching request prompt, to request a user to launch the application, where the application runs by using the running parameter.

An output manner may be giving a prompt on a graphical user interface (Graphical User Interface, GUI) by using a display, and displaying an input confirmation option, to receive a launching instruction of the user; or may be voice output, prompting the user in a voice manner, and waiting for confirmation of voice input of the user. FIG. 3 is a schematic diagram in which a prompt of a graphical user interface GUI is given.

A first launching unit 25 is configured to launch the application when a launching instruction of the user is received.

For example, as shown in FIG. 3, the user may select “Agree” or “Abandon”; if the user selects “Agree”, that is, the launching instruction of the user is received, for each application, the application is launched by using the acquired one or more parameters; and if the user selects “Abandon”, the application is not launched.

It can be seen that, according to the terminal provided in this embodiment of the present invention, a matching application and a running parameter of the application are determined by using an obtained contextual value of a contextor of the terminal, and the application is launched, where the application runs by using the running parameter, so that automatic launching of the application of the terminal can be implemented, thereby improving user experience of the terminal; also, after an application that needs to be automatically launched in a next step and a running parameter of the application are obtained, the application and the running parameter are provided, in a prompting manner, for a user to select, so that the terminal is not excessively mighty while being intelligent and thoughtful, and the user may independently decide whether to launch an application, but the prompt only needs to be simply confirmed by the user, without seeking for an application and a parameter related to the application, which provides the user with good interaction experience.

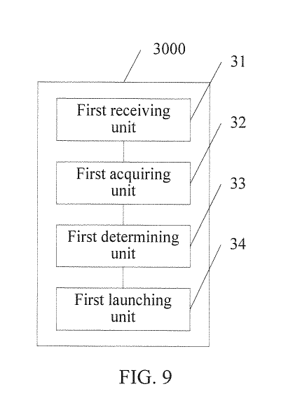

Refer to FIG. 9, which is a schematic structural diagram of still another terminal according to an embodiment of the present invention. The terminal 3000 includes a first receiving unit 31, a first acquiring unit 32, a first determining unit 33, and a first launching unit 34.

The first receiving unit 31 is configured to receive an operation request of a user, where the operation request executes the operation request on one associated application of at least two associated applications.

The first receiving unit 31 receives an operation request of a user, where the operation request executes the operation request on one associated application of the at least two associated applications. The operation request may be, but is not limited to, input performed by using a touchscreen, a keyboard, a mouse or the like, or may be voice input, or may be gesture input, or the like. For example, if a command is “open a music file” or “open a photograph”, this operation request of opening a music file needs to launch an application such as “music player”, and the terminal may include multiple associated applications “music players”, such as Baidu Music, TPlayer, DuoMi Music, and StormPlayer.

The first acquiring unit 32 is configured to acquire a contextual value of at least one contextor of the terminal, where the contextor represents an information source that is available to the terminal and that is related to human-computer interaction, and the contextual value is a value that represents the contextor.

Herein, one or more contextors include time, a location, a phone log, ambient noise, ambient light, application use, and the like. For the time, a contextual value may be obtained from a terminal clock or a time server; for the location, a contextual value may be obtained by means of a GPS or cellular triangulation; for the phone log, a contextual value may be obtained from a call record application; for the ambient noise, a contextual value may be obtained from a terminal microphone; for the ambient light, a contextual value may be obtained from a terminal light sensor; and for the application use, a contextual value may be obtained from an operating system. Generally, each contextual value may be obtained locally at a terminal from, for example, a sensor, and in some cases, these contextual values are stored in one or more local contextor logs. However, in some cases, contextor logs may be maintained and stored remotely, for example, in a server, and the terminal retrieves these contextor logs.

For the contextor, other contextors may also be provided by using other information (such as an operating system log) maintained by various apparatus sensors of a terminal or the terminal.

The contextor may further be a user mood, and the first acquiring unit 32 may include:

a fourth acquiring unit, configured to launch a camera of the terminal, and acquire an expression of the user; and

a fourth determining unit, configured to determine a contextual value of the user mood according to the expression of the user.

In addition, a developer may establish a new contextor used to decide and select an application. For example, it is considered to install an electronic compass in a third-party application of a mobile apparatus. In this case, a corresponding contextor used to provide a value (for example, an azimuth or a logical direction (north, northwest or the like)) of the electronic compass may be installed. The use of the newly installed contextor may be learned. For example, regardless of whether the new contextor is provided by a manufacturer of a mobile apparatus, a developer (“first party”) of an operating system of a mobile apparatus, or a developer of a third-party application, the new contextor is “inserted” into an existing frame.

A first determining unit 33 is configured to determine, from the at least two associated applications according to the contextual value, a first associated application that matches the contextual value.

One or more application launching decision engines may be used to make a decision on input of a contextual value of a contextor, to obtain an optimal application of multiple optional associated applications. Specifically, different application launching decision engines may make decisions according to one or more application launching decision rules or algorithms. A decision algorithm of an application launching decision engine may specifically include, but is not limited to, a Bayes (for example, naive Bayes) classifier, a decision tree (for example, very fast decision tree), a Support Vector Machine, a Hidden Markov Model, a Gaussian Mixture Model, or the like.

For example, assuming that in a historical operation, a user uses a “Baidu Music application” in the morning, uses a “TPlayer application” in the afternoon, and uses a “DuoMi Music application” in the evening, when current time of a contextor is 8:00 AM, an optimal application obtained through matching is the “Baidu Music application”; and when current time of the contextor is 2:00 PM, an optimal application obtained through matching is the “TPlayer application”. For another example, a contextual value of the contextor may perceive a mood mode of a user, and assuming that when a decision rule is “excited mood”, the user selects a “Baidu Music application”; and when a decision rule is “depressed mood”, the user selects a “TPlayer application”, when the current contextual value obtains an “excited mood” mode, an optimal application obtained through matching is the “Baidu Music application”. In an embodiment, contextors may further include evaluation and a use amount of social network friends for the multiple optional associated applications, and contextual values of these contextors may be acquired via a network, or may be obtained by a related context management module deployed in a server.

The first launching unit 34 is configured to launch the first associated application, to execute the operation request.

The first launching unit 34 launches the optimal application, to execute the operation request of the user. For example, if a music player obtained through matching is Baidu Music, music that the user requests to play is played by using Baidu Music.

It can be seen that, according to the terminal provided in this embodiment of the present invention, when selection is performed on an associated application corresponding to an operation request, according to an obtained contextual value of a contextor of the terminal, an associated application that matches the contextual value is determined, so that automatic selection and launching of the application can be implemented, thereby improving user experience of the terminal.

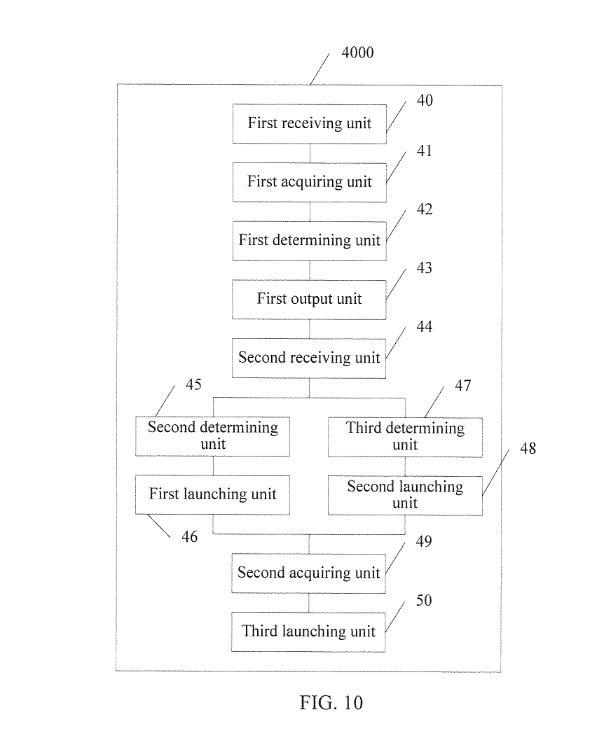

Refer to FIG. 10, which is a schematic structural diagram of still another terminal according to an embodiment of the present invention. The terminal 4000 includes a first acquiring unit 41, a first determining unit 42, a first output unit 43, a second receiving unit 44, a second determining unit 45, a first launching unit 46, a third determining unit 47, a second launching unit 48, a second acquiring unit 49, and a third launching unit 50.

The first receiving unit 40 is configured to receive an operation request of a user, where the operation request executes the operation request on one associated application of at least two associated applications.

The first acquiring unit 41 is configured to acquire a contextual value of at least one contextor of the terminal, where the contextor represents an information source that is available to the terminal and that is related to human-computer interaction, and the contextual value is a value that represents the contextor.

The first determining unit 42 is configured to determine, from the at least two associated applications according to the contextual value, a first associated application that matches the contextual value.

Functions of the first receiving unit 40, the first acquiring unit 41, and the first determining unit 42 are the same as those of the first receiving unit 31, the first acquiring unit 32, and the first determining unit 33 in the embodiment shown in FIG. 9 respectively, and details are not described herein again.

The first output unit 43 is configured to output an associated application selection prompt, to prompt the user to select the first associated application or another associated application of the at least two associated applications.

The second receiving unit 44 is configured to receive a selection instruction of the user.

The first output unit 43 outputs an optimal application obtained through matching and other applications associated with the operation request to the user, for the user to select. An output manner may be giving a prompt on a graphical user interface by using a display, and displaying an input confirmation option, to receive a launching instruction of the user; or may be voice output, prompting the user in a voice manner, and waiting for confirmation of voice input of the user. FIG. 6 is a schematic diagram of a graphical user interface recommended by an optimal application. In FIG. 6, a user is prompted that an optimal application recommended by a system is “TPlayer”. However, the user may also use “Baidu Music”, “DuoMi Music”, or “StormPlayer” to open a music file. The second receiving unit 44 receives the selection instruction of the user.

The second determining unit 45 is configured to determine a first running parameter of the first associated application according to the contextual value and the determined first associated application.

The first launching unit 46 is configured to launch the first associated application, to execute the operation request, where the first associated application runs by using the first running parameter.

If the received selection instruction of the user is to select a first application, that is, an optimal application, matching is performed according to the contextual value of the contextor to obtain one or more running parameters of the optimal application. Herein, running parameters of an application may be a file and data that are input to the application, or various configuration settings of the application, for example, a parameter of a music player application may be, but is not limited to, a music file currently played by the player application (that is, a data file of a played song), a type of a music file (such as classical music, pop music, jazz music, or light music), an interface style of a player, a volume setting of played music, or the like. The parameter of the application and history of the contextual value may also be learned over time, to learn to improve parameter selection of the application in a manner beneficial to the user.

The third determining unit 47 is configured to: if the selection instruction of the user is to select a second associated application of the at least two associated applications, determine a second running parameter of the second associated application according to the contextual value and the selected second associated application.

The second launching unit 48 is configured to launch the second associated application, to execute the operation request, where the second associated application runs by using the second running parameter.

If the received selection instruction of the user is to select a second associated application of other applications, a second running parameter of the second associated application needs to be acquired again according to the contextual value of the contextor, and the second associated application is launched, where the second associated application runs by using the second running parameter. Parameter matching and application launching processes of the second associated application are the same as parameter matching and application launching processes of the optimal application, and details are not described herein again.

The second acquiring unit 49 is configured to acquire a validity period selected by the user.

The third launching unit 50 is configured to: when the operation request of the user is received, launch an associated application that is in the validity period and that corresponds to the operation request, to execute the operation request.

As shown in FIG. 6, options selected and confirmed by a user include options 901 “All the time”, 902 “Recent use”, and 903 “Only this time”. Herein, the option 903 “Only this time” indicates that an associated application selected by the user is used only once, and when the associated application is needed in a subsequent similar command, selection needs to be decided again; the option 901 “All the time” indicates that an operation request of the user may be replaceably bound to an associated application selected by the user, and when the associated application is needed in a subsequent similar command, a current user selection is used, that is, the application is set to a default application. The option 902 “Recent use” is an option between the foregoing two options, which is neither applicable for once to an associated application currently selected by the user, nor applicable all the time to the application that is set to a default application, but is applicable to a same user command in a particular quantity of times or a particular period. Herein, the particular quantity of times or the particular period may be configured by a terminal, and may be adjusted by a user. For example, a user command requests to open an MP3 music file, optional associated applications include “Baidu Music”, “TPlayer”, “DuoMi Music”, “StormPlayer” and the like, and the user selects the “Baidu Music” and selects the “Recent use”. In configuration of an apparatus, “Recent use” is, for example, configured as 10 times (or 7 days), and for a subsequent similar command of opening a music file, the user selects a “Baidu Music” application in 10 times (or 7 days) by default to open the music file, and beyond the quantity of times or period, the user needs to re-decide to select an associated application for the command of opening a music file.

It can be seen that, according to the terminal provided in this embodiment of the present invention, when selection is performed on an associated application corresponding to an operation request, according to an obtained contextual value of a contextor of the terminal, an associated application that matches the contextual value is determined, so that automatic selection and launching of the application can be implemented, thereby improving user experience of the terminal; also, after an optimal application associated with the operation request is obtained through matching and a parameter of the optimal application is launched, a user is prompted to independently decide to select a recommended optimal application or other applications associated with the operation request, for the user to select, so that the terminal is not excessively mighty while being intelligent and thoughtful, but the prompt only needs to be simply confirmed by the user, without seeking for an application and a parameter related to the application, which provides the user with good interaction experience.

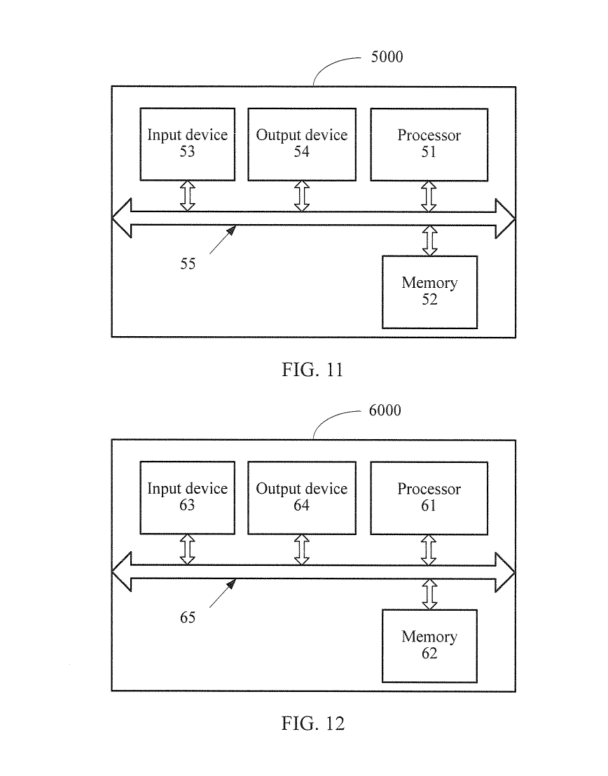

Refer to FIG. 11, which is a schematic structural diagram of still another terminal according to an embodiment of the present invention. The terminal 5000 includes:

a processor 51, a memory 52, an input device 53, an output device 54, and a bus system 55.

The processor 51 controls an operation of the terminal 5000, and the processor 51 may also be referred to as a central processing unit (Central Processing Unit, CPU). The processor 51 may be an integrated circuit chip, and has a signal processing capability. The processor 51 may also be a general purpose processor, a digital signal processor (DSP), an application-specific integrated circuit (ASIC), a field programmable gate array (FPGA), or another programmable logical device, discrete gate or transistor logical device, or discrete hardware component. The general purpose processor may be a microprocessor, or the processor may be any conventional processor, or the like.

The memory 52 may include a read only memory and a random access memory, and provides instructions and data to the processor 51. A part of the memory 52 may further include a non-volatile random access memory (NVRAM).

The components of the terminal 5000 are coupled by using the bus system 55, and the bus may be an industry standard architecture (Industry Standard Architecture, ISA) bus, a peripheral component interconnect (Peripheral Component Interconnect, PCI) bus, an extended industry standard architecture (Extended Industry Standard Architecture, EISA) bus or the like. The bus may be one or more physical lines, and when the bus is multiple physical lines, the bus may be classified into an address bus, a data bus, a control bus, and the like. In some other embodiments of the present invention, the processor 51, the memory 52, the input device 53, and the output device 54 may also be directly connected by using a communications line.

The input device 53 may be specifically implemented as a mouse, a keyboard, a microphone, or the like, and the output device 54 may be specifically implemented as a display, an audio device, or a video device. Particularly, functions of the input device 53 and the output device 54 may also be implemented by using one input/output device, for example, the input device 53 and the output device 54 are implemented as a touchscreen.

The processor 51 reads a computer program in the memory 52, so as to perform the following steps:

acquiring a contextual value of at least one contextor, where the contextor represents an information source that is available to the terminal and that is related to human-computer interaction, and the contextual value is a value that represents the contextor;

determining, according to a decision rule, an application that matches the contextual value;

determining a running parameter of the application according to the acquired contextual value and the determined application; and

launching the application, where the application runs by using the running parameter.

In an implementation manner, that the processor 51 performs the step of determining, according to a decision rule, an application that matches the contextual value includes:

launching an application launching decision engine, so that the application launching decision engine determines, according to the decision rule, the application that matches the contextual value; and

acquiring the application that matches the contextual value and that is output by the application launching decision engine, where

the application launching decision engine includes the following decision rule: a Bayes classifier, a decision tree, a Support Vector Machine, a Hidden Markov Model, or a Gaussian Mixture Model.

In another implementation manner, that the processor 51 performs the step of determining a running parameter of the application according to the acquired contextual value and the determined application includes:

launching an application parameter decision engine, so that the application parameter decision engine determines the running parameter of the application according to the decision rule; and

acquiring the running parameter of the application that is output by the application parameter decision engine, where

the application parameter decision engine includes the following decision rule: a Bayes classifier, a decision tree, a Support Vector Machine, a Hidden Markov Model, or a Gaussian Mixture Model.

In still another implementation manner, the processor 51 further performs the following steps:

outputting a launching request prompt, to request a user to launch the application, where the application runs by using the running parameter, where

that the processor 51 performs the step of launching the application includes:

launching the application when a launching instruction of the user is received.

The computer program included in the processor 51 provided in this embodiment of the present invention may be further implemented as a first acquiring unit, a first determining unit, a second determining unit, and a first launching unit. For functions implemented by the four units, reference may be made to description in the foregoing embodiments, and details are not described herein again.

It can be seen that, according to the terminal provided in this embodiment of the present invention, a matching application and a running parameter of the application are determined by using an obtained contextual value of a contextor of the terminal, where the application runs by using the running parameter, so that automatic launching and running of the application of the terminal can be implemented, thereby improving user experience of the terminal.

Refer to FIG. 12, which is a schematic structural diagram of still another terminal according to an embodiment of the present invention. The terminal 6000 includes a processor 61, a memory 62, an input device 63, an output device 64, and a bus system 65.

The processor 61 controls an operation of the terminal 6000, and the processor 61 may also be referred to as a central processing unit (Central Processing Unit, CPU). The processor 61 may be an integrated circuit chip, and has a signal processing capability. The processor 61 may also be a general purpose processor, a digital signal processor (Digital Signal Processing, DSP), an application-specific integrated circuit (Application Specific Integrated Circuit, ASIC), a field programmable gate array (Field-Programmable Gate Array, FPGA), or another programmable logical device, discrete gate or transistor logical device, or discrete hardware component. The general purpose processor may be a microprocessor, or the processor may be any conventional processor, or the like.

The memory 62 may include a read only memory and a random access memory, and provides instructions and data to the processor 61. A part of the memory 62 may further include a non-volatile random access memory (NVRAM).

The components of the terminal 6000 are coupled by using the bus system 65, and the bus may be an industry standard architecture (Industry Standard Architecture, ISA) bus, a peripheral component interconnect (Peripheral Component Interconnect, PCI) bus, an extended industry standard architecture (Extended Industry Standard Architecture, EISA) bus or the like. The bus may be one or more physical lines, and when the bus is multiple physical lines, the bus may be classified into an address bus, a data bus, a control bus, and the like. In some other embodiments of the present invention, the processor 61, the memory 62, the input device 63, and the output device 64 may also be directly connected by using a communications line.

The input device 63 may be specifically implemented as a mouse, a keyboard, a microphone, or the like, and the output device 64 may be specifically implemented as a display, an audio device, or a video device. Particularly, functions of the input device 63 and the output device 64 may also be implemented by using one input/output device, for example, the input device 63 and the output device 64 are implemented as a touchscreen.

The processor 61 reads a computer program in the memory 62, so as to perform the following steps:

receiving an operation request of a user, where the operation request executes the operation request on one associated application of at least two associated applications;

acquiring a contextual value of at least one contextor of the terminal, where the contextor represents an information source that is available to the terminal and that is related to human-computer interaction, and the contextual value is a value that represents the contextor;

determining, from the at least two associated applications according to the contextual value, a first associated application that matches the contextual value; and

launching the first associated application, to execute the operation request.

In an implementation manner, the processor 61 further performs the following step:

determining a first running parameter of the first associated application according to the contextual value and the determined first associated application, where

that the processor 61 performs the step of launching the first associated application, to execute the operation request includes:

launching the first associated application, to execute the operation request, where the first associated application runs by using the first running parameter.

In another implementation manner, the processor 61 further performs the following steps:

outputting an associated application selection prompt, to prompt the user to select the first associated application or another associated application of the at least two associated applications; and

receiving a selection instruction of the user, where

that the processor 61 performs the step of launching the first associated application, to execute the operation request includes:

if the selection instruction of the user is to select the first associated application, launching the first associated application, to execute the operation request, where the first associated application runs by using the first running parameter.

In still another implementation manner, if the selection instruction of the user is to select a second associated application of the at least two associated applications, the processor 61 further performs the following steps:

determining a second running parameter of the second associated application according to the contextual value and the selected second associated application; and

launching the second associated application, to execute the operation request, where the second associated application runs by using the second running parameter.

In still another implementation manner, after performing the step of receiving a selection instruction of the user, the processor further performs the following steps:

acquiring a validity period selected by the user; and

when an operation request of the user is received, launching an associated application that is in the validity period and that corresponds to the operation request, to execute the operation request.

In still another implementation manner, that the processor 61 performs the step of acquiring a validity period selected by the user includes:

outputting a selection interface of the validity period, to prompt the user to perform validity period selection; and

acquiring the validity period selected by the user.

In still another implementation manner, the contextor is a user mood, and that the processor 61 performs the step of acquiring a contextual value of at least one contextor of the terminal includes:

launching a camera of the terminal, and acquiring an expression of the user; and

determining a contextual value of the user mood according to the expression of the user.

The computer program included in the processor 61 provided in this embodiment of the present invention may be further implemented as a first receiving unit, a first acquiring unit, a first determining unit, and a first launching unit. For functions implemented by the four units, reference may be made to description in the foregoing embodiments, and details are not described herein again.

It can be seen that, according to the terminal provided in this embodiment of the present invention, when selection is performed on an associated application corresponding to an operation request, according to an obtained contextual value of a contextor of the terminal, an associated application that matches the contextual value is determined, so that automatic selection and launching of the application can be implemented, thereby improving user experience of the terminal.

It should be noted that, for brief description, the foregoing method embodiments are represented as a series of actions. However, a person skilled in the art should appreciate that the present invention is not limited to the described order of the actions, because according to the present invention, some steps may be performed in other orders or simultaneously. In addition, a person skilled in the art should also understand that the embodiments described in this specification all belong to exemplary embodiments, and the involved actions and modules are not necessarily mandatory to the present invention.

In the foregoing embodiments, the description of each embodiment has respective focuses. For a part that is not described in detail in an embodiment, reference may be made to related descriptions in other embodiments.

What is described above is merely exemplary embodiments of the technical solutions of the present invention, but is not intended to limit the protection scope of the present invention. Any modification, equivalent replacement, or improvement made without departing from the spirit and principle of the present invention shall fall within the protection scope of the present invention.

What is claimed is:

1. A terminal application launching method, the method comprising:
acquiring a contextual value of at least one contextor, wherein the contextor represents an information source that is available to a terminal and that is related to human-computer interaction, and the contextual value is a value that represents the contextor;
determining, according to a decision rule, an application that matches the contextual value;
determining a running parameter of the application according to the acquired contextual value and the determined application; and
launching the application, wherein the application runs by using the running parameter.

2. The method according to claim 1, wherein determining, according to the decision rule, the application that matches the contextual value comprises:
launching an application launching decision engine, so that the application launching decision engine determines, according to the decision rule, the application that matches the contextual value; and
acquiring the application that matches the contextual value and that is output by the application launching decision engine;
wherein the application launching decision engine comprises the following decision rule:
a Bayes classifier, a decision tree, a Support Vector Machine, a Hidden Markov Model, or a Gaussian Mixture Model.

3. The method according to claim 1, wherein determining the running parameter of the application according to the acquired contextual value and the determined application comprises:
launching an application parameter decision engine, so that the application parameter decision engine determines the running parameter of the application according to the decision rule; and
acquiring the running parameter of the application that is output by the application parameter decision engine;
wherein the application parameter decision engine comprises the following decision rule:
a Bayes classifier, a decision tree, a Support Vector Machine, a Hidden Markov Model, or a Gaussian Mixture Model.

4. The method according to a claim 1, further comprising:
outputting a launching request prompt, to request a user to launch the application;
wherein the application runs by using the running parameter;
wherein launching the application comprises:
launching the application when a launching instruction of the user is received.

5. A terminal application launching method, the method comprising:
receiving an operation request of a user, wherein the operation request is executed on one association application in at least two association applications;
acquiring a contextual value of at least one contextor of a terminal, wherein the contextor represents an information source that is available to a terminal and that is related to human-computer interaction, and the contextual value is a value that represents the contextor;
determining, from the at least two associated applications according to the contextual value, a first associated application that matches the contextual value; and
launching the first associated application, to execute the operation request.

6. The method according to claim 5, further comprising:
determining a first running parameter of the first associated application according to the contextual value and the determined first associated application, wherein the first associated application runs by using the first running parameter.

7. The method according to claim 6, further comprising:
outputting an associated application selection prompt, to prompt the user to select the first associated application or another associated application of the at least two associated applications; and
receiving a selection instruction of the user;
wherein launching the first associated application, to execute the operation request comprises:
when the selection instruction of the user is to select the first associated application, launching the first associated application, to execute the operation request, wherein the first associated application runs by using the first running parameter.

8. The method according to claim 7, wherein when the selection instruction of the user is to select a second associated application of the at least two associated applications, the method further comprises:
determining a second running parameter of the second associated application according to the contextual value and the selected second associated application; and
launching the second associated application, to execute the operation request, wherein the second associated application runs by using the second running parameter.

9. The method according to claim 7, wherein after receiving the selection instruction of the user, the method further comprises:
acquiring a validity period selected by the user; and
when an operation request of the user is received, launching an associated application that is in the validity period and that corresponds to the operation request, to execute the operation request.

10. The method according to claim 9, wherein acquiring the validity period selected by the user comprises:
outputting a selection interface of the validity period, to prompt the user to perform validity period selection, wherein the validity period comprises:
all the time, recent use, or only this time, wherein the validity period of recent use is a preset quantity of use times or a preset use time; and
acquiring the validity period selected by the user.

11. The method according to claim 5, wherein
the contextor is a user mood; and
acquiring the contextual value of at least one contextor of the terminal comprises:
launching a camera of the terminal, and acquiring an expression of the user; and
determining a contextual value of the user mood according to the expression of the user.

12. A terminal, comprising:
at least one processor; and
a memory, wherein the memory is configured to provide instructions and data to the processor;
wherein the processor is configured to:
acquire a contextual value of at least one contextor, wherein the contextor represents an information source that is available to a terminal and that is related to human-computer interaction, and the contextual value is a value that represents the contextor;
determine, according to a decision rule, an application that matches the contextual value;
determine a running parameter of the application according to the acquired contextual value and the determined application; and
launch the application, wherein the application runs by using the running parameter.

13. The terminal according to claim 12, wherein the processor is further configured to:
launch an application launching decision engine, so that the application launching decision engine determines, according to the decision rule, the application that matches the contextual value; and
acquire the application that matches the contextual value and that is output by the application launching decision engine;
wherein the application launching decision engine comprises the following decision rule:
a Bayes classifier, a decision tree, a Support Vector Machine, a Hidden Markov Model, or a Gaussian Mixture Model.

14. The terminal according to claim 12, wherein the processor further configured to:
launch an application parameter decision engine, so that the application parameter decision engine determines the running parameter of the application according to the decision rule; and
acquire the running parameter of the application that is output by the application parameter decision engine;
wherein the application parameter decision engine comprises the following decision rule:
a Bayes classifier, a decision tree, a Support Vector Machine, a Hidden Markov Model, or a Gaussian Mixture Model.

15. The terminal according to claim 12, wherein the processor further configured to:
output a launching request prompt, to request a user to launch the application;
wherein the application runs by using the running parameter;
wherein the application is launched when a launching instruction of the user is received.

16. A terminal, comprising:
at least one processor; and
a memory, wherein the memory is configured to provide instructions and data to the processor;
wherein the processor is configured to:
receive an operation request of a user, wherein the operation request executes the operation request on one associated application of at least two associated applications;
acquire a contextual value of at least one contextor of the terminal, wherein the contextor represents an information source that is available to the terminal and that is related to human-computer interaction, and the contextual value is a value that represents the contextor;
determine, from the at least two associated applications according to the contextual value, a first associated application that matches the contextual value; and
launch the first associated application, to execute the operation request.

17. The terminal according to claim 16, wherein the processor is further configured to:
determine a first running parameter of the first associated application according to the contextual value and the determined first associated application, wherein the first associated application runs by using the first running parameter.

18. The terminal according to claim 17, wherein the processor is further configured to:
output an associated application selection prompt, to prompt the user to select the first associated application or another associated application of the at least two associated applications; and
receive a selection instruction of the user;
wherein the processor is further configured to:
when the selection instruction of the user is to select the first associated application, launch the first associated application, to execute the operation request, wherein the first associated application runs by using the first running parameter.

19. The terminal according to claim 18, wherein when the selection instruction of the user is to select a second associated application of the at least two associated applications, the processor is further configured to:
determine a second running parameter of the second associated application according to the contextual value and the selected second associated application; and
launch the second associated application, to execute the operation request, wherein the second associated application runs by using the second running parameter.

20. The terminal according to claim 16, wherein
the contextor is a user mood;
wherein the processor is further configured to:
launch a camera of the terminal, and acquire an expression of the user; and
determine a contextual value of the user mood according to the expression of the user.
